(19) United States
(12) Patent Application Publication
(10) Pub. No.: US 2026/0057207 A1
(43) Pub. Date: Feb. 26, 2026

(54) Boolean Neural Network

(71) Applicant: Wolfram Group LLC, Champaign, IL (US)

(72) Inventors: Stephen Wolfram, Concord, MA (US); Richard Assar, Edinburgh (GB)

(21) Appl. No.: 19/308,070

(22) Filed: Aug. 22, 2025

Related U.S. Application Data
(60) Provisional application No. 63/686,127, filed on Aug. 22, 2024.

(51) Int. Cl. G06N 3/04; G06N 3/082

(52) U.S. Cl. CPC G06N 3/04; G06N 3/082

(57) ABSTRACT

First Boolean computational nodes in a first layer of a neural network receive first Boolean inputs, and the first Boolean computational nodes generate first Boolean outputs based on the plurality of first Boolean inputs. Second Boolean computational nodes in a second layer of the neural network receive second Boolean inputs. The second Boolean inputs are based on the first Boolean outputs generated by the first Boolean computational nodes. The second Boolean computational nodes generate weighted second Boolean inputs by respectively applying respective Boolean weighting functions to at least some of second Boolean inputs, and the second Boolean computational nodes generate second Boolean outputs based on the weighted second Boolean inputs.

### CROSS REFERENCES TO RELATED APPLICATIONS

This application claims the benefit of U.S. Provisional Patent App. No. 63/686,127, entitled “Neural Network That Operates on Boolean-Valued Inputs,” filed on Aug. 22, 2024, the disclosure of which is expressly incorporated herein by reference in its entirety for all purposes.

### BACKGROUND

The approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A neural network is a computational model generally based on the structure of biological neurons in a brain and how the biological neurons interact. A neural network comprises a plurality of interconnected computational units sometimes referred to as “artificial neurons” or just “neurons.” Each artificial neuron generates an output using signals received from other artificial neurons connected to the artificial neuron. The output may be sent to other connected artificial neurons, which may in turn use the output (and outputs from other artificial neurons) to generate another output. The inputs to a neuron are weighted according to corresponding weights, and each neuron computes the output by applying a non-linear function (an “activation function”) to the weighted inputs.

Conventional neural networks comprise neurons arranged into layers. Typically, a neural network comprises an input layer, an output layer, and one or more (or zero) intermediate layers between the input layer and the output layer, and signals propagate from the input layer to the output layer.

Behavior of the neural network changes as the weights of the activation functions are changed. Neural networks are typically trained by applying training data to a neural network, iteratively changing weights, and comparing outputs of the neural network to a desired output as the weights are changed. One common technique for training neural networks is referred to as “backpropagation.” In backpropagation, a gradient of a loss function with respect to the weights of the neural network is computed one layer at a time, starting at a last layer and moving backward. Weights are iteratively adjusted in a negative direction of the gradient, such as by a technique referred to as “stochastic gradient descent.”

### SUMMARY

In an embodiment, a neural network comprises a first layer of first Boolean computational nodes. Each first Boolean computational node is configured to: receive one or more first Boolean inputs; and generate a first Boolean output based on the one or more first Boolean inputs. The neural network also comprises a second layer of second Boolean computational nodes. Each second Boolean computational node is configured to: receive one or more second Boolean inputs, the one or more second Boolean inputs based on the first Boolean outputs generated by the first layer of first Boolean computational units; generate one or more weighted second Boolean inputs by respectively applying one or more Boolean functions to the one or more second Boolean inputs; and generate a second Boolean output based on the one or more weighted second Boolean inputs.

In another embodiment, a method for processing Boolean data using a neural network, includes: receiving, at a plurality of first Boolean computational nodes in a first layer of the neural network, a plurality of first Boolean inputs; generating, at the plurality of first Boolean computational nodes, a plurality of first Boolean outputs based on the plurality of first Boolean inputs; receiving, at a plurality of second Boolean computational nodes in a second layer of the neural network, a plurality of second Boolean inputs, the plurality of second Boolean inputs based on the first Boolean outputs generated by the plurality of first Boolean computational nodes; generating, at the plurality of second Boolean computational nodes, a plurality weighted second Boolean inputs by respectively applying, at the plurality of second Boolean computational nodes, respective Boolean weighting functions to at least some of second Boolean inputs in the plurality of second Boolean inputs, and generating, at the plurality of second Boolean computational nodes, a plurality of second Boolean outputs based on the plurality weighted second Boolean inputs.

In yet another embodiment, a method for training a Boolean neural network (that includes a first layer of first Boolean computational nodes and a second layer of second Boolean computational nodes) includes: applying, by a computer, Boolean training data to inputs of the Boolean neural network; generating, by the computer, error measurements based on comparing actual Boolean outputs of the Boolean neural network to desired Boolean outputs, the actual Boolean outputs generated by the Boolean neural network based on Boolean training data; and iteratively adjusting, by the computer, parameters of the Boolean neural network to reduce a degree of error between the actual Boolean outputs generated by the Boolean neural network based on Boolean training data and the desired Boolean outputs, including iteratively adjusting Boolean weighting parameters used by the second Boolean computational nodes to modify Boolean inputs to the second Boolean computational nodes.

In still another embodiment, a system for training a Boolean neural network (that includes a first layer of first Boolean computational nodes and a second layer of second Boolean computational nodes) comprises: one or more processors configured to execute machine readable instructions; and one or more memories coupled to the one or more processors. The one or more memories store machine readable instructions that, when executed by the one or more processors, cause the one or more processors to: apply Boolean training data to inputs of the Boolean neural network; generate error measurements based on comparing actual Boolean outputs of the Boolean neural network to desired Boolean outputs, the actual Boolean outputs generated by the Boolean neural network based on Boolean training data; and iteratively adjust parameters of the Boolean neural network to reduce a degree of error between the actual Boolean outputs generated by the Boolean neural network based on Boolean training data and the desired Boolean outputs, including iteratively adjusting Boolean weighting parameters used by the second Boolean computational nodes to modify Boolean inputs to the second Boolean computational nodes.

### BRIEF DESCRIPTION OF THE DRAWINGS

FIG. 1 is a simplified block diagram of an example neural network 100 that implements, and/or is used in conjunction with, aspects of neural network techniques described in the present application, according to an embodiment.

FIG. 2 is table showing examples of partial derivatives of 2-input Boolean functions, according to an embodiment.

FIG. 3 is a diagram of an example computer system that is used to implement at least a portion of the example neural network of FIG. 1, according to an embodiment.

FIG. 4 is a simplified flow diagram of an example method for processing Boolean data using a neural network, according to an embodiment.

FIG. 5 is a simplified flow diagram of an example method for training a Boolean neural network, according to an embodiment.

### DETAILED DESCRIPTION

In conventional neural networks, the inputs to neurons and the weights applied to the inputs are real numbers (or multi-bit digital approximations of real numbers), and the output of each neuron is computed as a function (the “activation function”) of all of the weighted inputs to the neuron.

In embodiments described herein, a neural network includes computational nodes that receive Boolean inputs and generate Boolean outputs based on the Boolean inputs. For example, generating the Boolean outputs includes the computational nodes applying Boolean functions to Boolean inputs, in some embodiments. In some embodiments, computational nodes apply Boolean weighting functions to Boolean inputs to generate weighted Boolean inputs, and the computational nodes generate Boolean outputs based on the weighted Boolean inputs. As used herein, a “Boolean input” is an input that has a value from a two-element set, e.g., {0, 1}, {-1, +1}, {Truc, False}, etc.; a “Boolean output” is an output that has a value from the two-element set; and a “Boolean function” is a function having arguments with values from the two-element set (i.e., inputs to the Boolean function are Boolean inputs), and a result that has a value from the two-element set (i.e., the output of the Boolean function is a Boolean output). Boolean functions are sometimes referred to as “logical functions.”

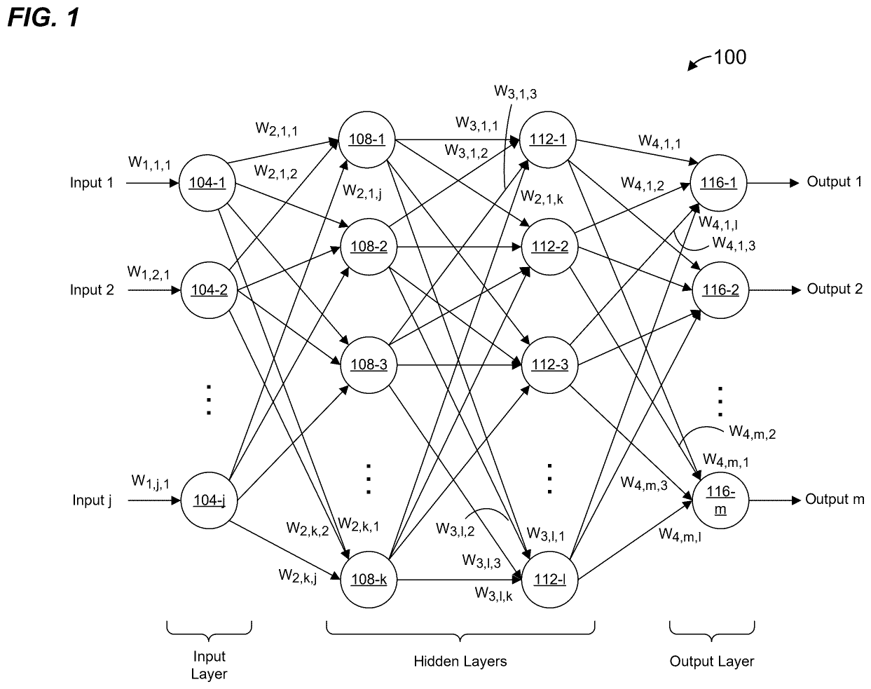

FIG. 1 is a simplified block diagram of an example neural network 100 that implements, and/or is used in conjunction with, aspects of neural network techniques described in the present application, according to an embodiment.

The neural network 100 includes a plurality of layers. Each layer may include a quantity of nodes. For example, an input layer may include j input nodes 104 that receive input values, where j is a suitable positive integer. The input values are Boolean values, in an embodiment. Although FIG. 1 illustrates each input node 104 receiving one input value, each of one or more of the input nodes 104 may receive multiple input values, in some embodiments.

The neural network 100 may also include one or more layers of hidden nodes 108, 112. FIG. 1 illustrates two layers of hidden nodes 108, 112, as an example, but the neural network 100 may include other suitable numbers of hidden node layers different than two.

An output layer of the neural network 100 may also include m of output nodes 116, where m is a suitable positive integer. Each output node 116 may receive data that has been manipulated or processed by the hidden nodes 108, 112, and may generate a respective output value. The output values generated by the output nodes 116 are Boolean values, in an embodiment.

In some embodiments, the neural network 100 omits the hidden nodes 108, 112, and each output node 116 may receive data that has been manipulated or processed by the input nodes 108, 112.

Each of at least some of the nodes 104, 108, 112, 116 may perform one or more suitable Boolean and/or mathematical operations on one or more inputs to the node, according to various embodiments. Examples of Boolean operations performed by the nodes 104, 108, 112, 116 include one or more of an AND operation, an OR operation, an exclusive-OR (XOR) operation, a Not AND (NAND) operation, a Not OR (NOR) operation, a Majority operation, etc. A Majority operation evaluates to false (or 0, or −1, etc.) when half or more inputs are false (or 0, or −1, etc.), and evaluates to true (or 1, or +1, etc.) otherwise.

In some embodiments, each of at least some of the nodes 104, 108, 112, 116 may perform one or more respective weighting functions on one or more inputs to the node to generate one or more weighted inputs, and the node may perform a suitable Boolean and/or mathematical operation on the one or more weighted inputs to generate an output.

In some embodiments, the weighting functions are Boolean weighting functions performed on Boolean inputs. Examples of Boolean weighting functions include passing a Boolean input unchanged (i.e., weighted input=input), a NOT function (i.e., weighted input is one when the input is zero, and weighted input is zero when the input one), setting the weighted input to a logic one regardless of the Boolean input, setting the weighted input to a logic zero regardless of the Boolean input, etc. A particular Boolean weighting function to be applied to an input may be indicated by a parameter W.

In some embodiments, each of at least some of the nodes 104, 108, 112, 116 may additionally or alternatively perform a pruning operation on one or more inputs to the node, and the node may perform a suitable Boolean on the one or more inputs that are not pruned (“unpruned”) to generate an output, i.e., the node performs a Boolean operation based on a set of inputs that excludes the pruned inputs, i.e., the node does not use the pruned inputs to generate an output. As an illustrative example, a node receives 63 inputs from 63 other nodes, and performs a pruning operation on twenty of the inputs, leaving 43 unpruned inputs; the node then performs a Majority operation based on the 43 unpruned inputs and not based on the 20 pruned inputs, in an embodiment. In an embodiments in which pruning is utilized, an indicator P indicates whether a corresponding input is to be pruned.

The neural network 100 may be characterized by one or more neural network block parameters. Neural network block parameters may include one or more of a number of layers, a number of nodes in each layer, a connection mapping between the layers, activation functions for each node, and one or more hyperparameters (e.g., weight values and bias values for each node). Neural network block parameters may further include an indication of a previously trained neural network 100, one or more submodules within the neural network 100, etc.

The neural network 100 may be implemented using hardware circuitry, machine-readable instructions executed by a hardware processor (e.g., a general purpose processor, a special purpose processor (e.g., a graphical processing unit (GPU), an artificial intelligence (AI) accelerator processor, etc.), or a suitable combination of hardware circuitry and machine-readable instructions executed by a hardware processor. For example, at least some of the nodes 104, 108, 112, 116 may be implemented using one or more sets of hardware circuitry, in an embodiment. In another embodiment, at least some of the nodes 104, 108, 112, 116 are implemented additionally or alternatively using machine-readable instructions executed by one or more hardware processors. When the neural network 100 is implemented using multiple sets of hardware circuitry and/or multiple hardware processors (which execute machine-readable instructions), different computing nodes may be communicatively coupled using suitable communication links such as busses, cables, wireless links, line-of-sight optical links, etc.

In some embodiments, one or more of the nodes 104, 108, 112, 116 are configured to implement cellular automata.

In some embodiments, some of the nodes 104, 108, 112, 116 are implemented using a same computational hardware circuit that is time-shared.

In some embodiments, an activation function implemented by a node may include multiplying a set of one or more input values with a set of one or more weight values, summing the result, and adding a bias value to the sum. Weight values may be used to affect output values (e.g., positive weights may increase the value of an output and negative weights may decrease the value of an output). Weights may be utilized to increase or decrease the effect of a particular input value, set of data, source of data, or the like. A bias may be a constant value (e.g., a constant vector) that is added to the product of inputs multiplied by weights. The bias value may be used to offset a particular result or output, and may be used to reduce variance. That is, a bias may shift the output of an activation function towards negative or positive value.

Behavior of the neural network 100 changes as the weight parameters W are changed, in an embodiment. In some embodiments in which activation functions of at least some of the nodes 104 can be changed, behavior of the neural network 100 changes also as the activation functions of the at least some of the nodes 104 are changed. In some embodiments in pruning is utilized, behavior of the neural network 100 changes also as pruning parameters P are changed.

In various embodiments in which at least some of the input signals and output signals are Boolean and at least some of the nodes 104 are configured to apply Boolean functions, behavior of the neural network 100 changes as one of, or any suitable combination of two or more of, the following are changed: i) weight parameters W indicating Boolean weighting functions, ii) Boolean functions applied by the nodes 104, and iii) pruning parameters P.

In some embodiments, the neural network 100 is trained by i) applying training data to the inputs of the input layer, ii) iteratively changing one or more of a) weights W, b) activation functions performed by the nodes 104, and c) pruning parameters P, and iii) comparing outputs of the neural network to a desired output as the iterative changes are performed. In an embodiment, training the neural network 100 includes using a cost function (or “loss function”) to measure a difference between actual outputs of the neural network 100 (e.g., when training data is input to the neural network 100) and desired outputs of the neural network 100, and parameters of the neural network 100 such as described above are iteratively changed in an attempt to minimize the loss function.

In some embodiments, training the neural network 100 includes using a backpropagation technique in which a gradient of the loss function with respect to the parameters of the neural network 100 such as described above is computed one layer at a time, starting at the output layer and moving backward towards the input layer. Parameters of the neural network 100 such as described above are iteratively adjusted in a negative direction of the gradient, such as according to a “stochastic gradient descent” technique or another suitable technique.

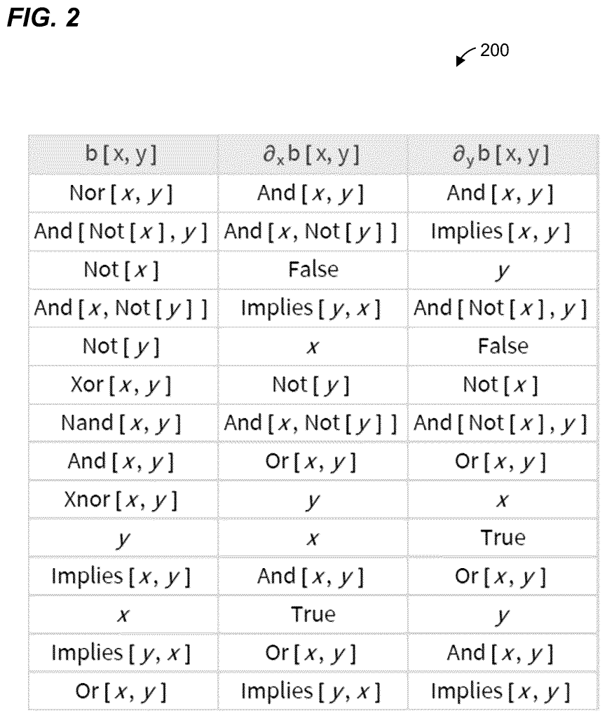

A gradient descent technique involves calculating a derivative of the loss function with regard to parameters the neural network 100 such as described above. With regard to Boolean functions, a “partial derivative” of a Boolean function with respect to a Boolean input x at the x as can be considered as indicating whether the output of the Boolean function changes when x is flipped started from the value given. For instance, the derivative of the function x with respect to x is True, in an embodiment. As another example, the partial derivative of the Boolean function XOR[x, y] with respective to x is NOT[y], in an embodiment. FIG. 2 is table 200 showing examples of partial derivatives of 2-input Boolean functions, according to an embodiment.

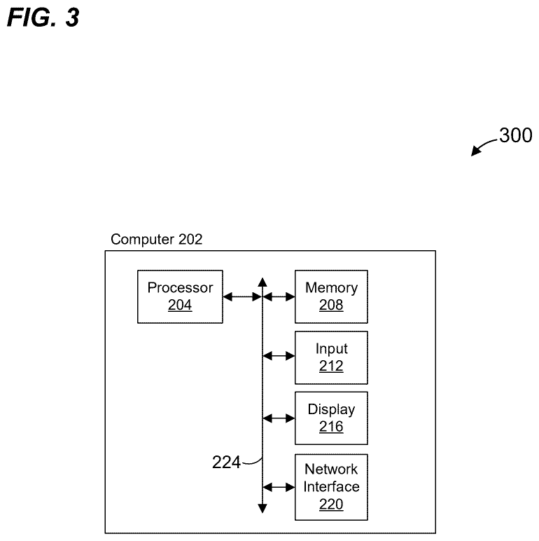

FIG. 3 is a diagram of an example computer system 300 that is used to implement at least a portion of a neural network such as the example neural network 100 of FIG. 1, according to an embodiment.

The computer system 300 includes a computer 302 having one or more processors 304 and one or more memory devices 308. The computer 302 also includes, or is coupled to, one or more input devices 312, in an embodiment. Additionally, the computer 302 includes, or is coupled to, one or more display devices 316, in an embodiment. In some embodiments, the computer 302 includes one or more network interface devices 320. The one or more processors 304, the one or more memory devices 308 (sometime referred to herein as “the memory device 308” for brevity), the one or more input devices 312 (sometime referred to herein as “the input device 312” for brevity), the one or more display devices 316 (sometime referred to herein as “the display device 316” for brevity), the one or more network interface devices 320 (sometime referred to herein as “the network interface device 320” for brevity), etc., may be communicatively coupled via one or more busses 324 (sometime referred to herein as “the bus 324” for brevity). In other embodiments, the computer 302 may have other suitable structures and/or components, and/or may omit some of the components illustrated in FIG. 3.

The one or more processors 304 (sometime referred to herein as “the processor 204” for brevity) may comprise one or more a general purpose processor (e.g., a central processing unit (CPU)), one or more special purpose processors (e.g., a co-processor, a GPU, an AI accelerator, etc.). At least one of the one or more processors 304 executes machine readable instructions stored in the memory device 308. The memory device 308 includes one or more of random access memory (RAM), read only memory (ROM), a solid state memory, a magnetic disk drive, an optical disk drive, etc.

The input device 312 include one or more suitable input devices such as a keyboard, a keypad, a mouse, a trackball, one or more buttons, a touch screen that overlays a display device, a microphone, etc. In some embodiments, the input devices 312 are omitted. In some embodiments, the display device 316 is omitted.

The network interface device 320 comprises one or more suitable network interface devices (NICs) such as a wired network NIC, a wireless network NIC, etc. In some embodiments, the network interface devices 320 are omitted.

In some embodiments, the memory 308 stores machine-readable instructions that, when executed by the processor 304, causes the processor to perform operations such as described herein.

In other embodiments, a network of multiple computers systems like the computer system 300 is used to implement at least a portion of a neural network such as the example neural network 100 of FIG. 1, according to an embodiment. In such embodiments, the multiple computers systems are communicatively coupled together via suitable communication links and, optionally, network switching equipment such as routers, network switches, etc.

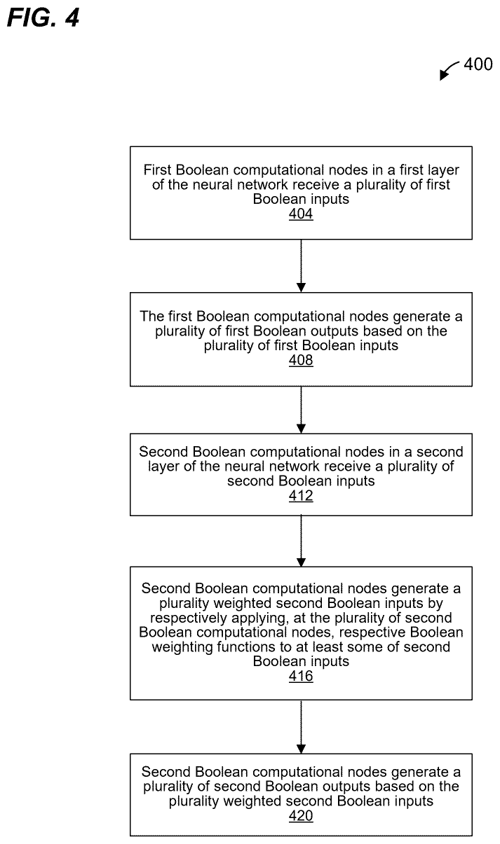

FIG. 4 is a simplified flow diagram of an example method 400 for processing Boolean data using a neural network, according to an embodiment. The method 400 is implemented in the neural network 100 of FIG. 1, in an embodiment, and the method 400 is described with reference to FIG. 1 for ease of explanation. In other embodiments, the method 400 is implemented in another suitable neural network different than the neural network 100 of FIG. 1.

In some embodiments, the method 400 is implemented by a computing system such as the computing system 300 of FIG. 3, or another suitable computing system. In other embodiments, the method 400 is implemented by a network of multiple computers systems that are communicatively interconnected.

At block 404, a plurality of first Boolean computational nodes in a first layer of the neural network receive a plurality of first Boolean inputs.

At block 408, the plurality of first Boolean computational nodes generate a plurality of first Boolean outputs based on the plurality of first Boolean inputs.

At block 412, a plurality of second Boolean computational nodes in a second layer of the neural network receive a plurality of second Boolean inputs. The one or more second Boolean inputs are based on the first Boolean outputs generated by the plurality of first Boolean computational nodes, in an embodiment.

At block 416, the plurality of second Boolean computational nodes generate a plurality weighted second Boolean inputs by respectively applying, at the plurality of second Boolean computational nodes, respective Boolean weighting functions to at least some of second Boolean inputs in the plurality of second Boolean inputs.

At block 420, the plurality of second Boolean computational nodes generate a plurality of second Boolean outputs based on the plurality weighted second Boolean inputs.

In another embodiment, the method 400 further comprises: generating, at the plurality of first Boolean computational nodes, a plurality weighted first Boolean inputs by respectively applying, at the plurality of first Boolean computational nodes, respective Boolean weighting functions to the plurality of first Boolean inputs, and wherein generating the plurality of first Boolean outputs at block 408 comprises generating the plurality of first Boolean outputs based on the plurality of weighted first Boolean inputs.

In another embodiment, each of at least some of the first Boolean computational nodes is configured to implement a plurality of Boolean functions; and wherein generating the plurality of first Boolean outputs at block 408 comprises generating, at each of the at least some of the first Boolean computational nodes, a respective first Boolean output by applying a particular Boolean function to a set of Boolean values corresponding to a set of first Boolean inputs, the particular Boolean function selected from the plurality of plurality of Boolean functions.

In another embodiment, each of at least some of the second Boolean computational nodes is configured to implement a plurality of Boolean functions; and wherein generating the plurality of second Boolean outputs at block 420 comprises generating, at each of the at least some of the second Boolean computational nodes, a respective second Boolean output by applying a particular Boolean function to a set of weighted second Boolean inputs, the particular Boolean function selected from the plurality of plurality of Boolean functions.

In another embodiment, the method 400 further comprises: at each of at least some of the second Boolean computational nodes, pruning one or more second Boolean inputs to the second Boolean computational node; wherein generating the plurality weighted second Boolean inputs at block 416 comprises respectively applying, at the plurality of second Boolean computational nodes, respective Boolean weighting functions to second Boolean inputs in the plurality of second Boolean inputs that are not pruned.

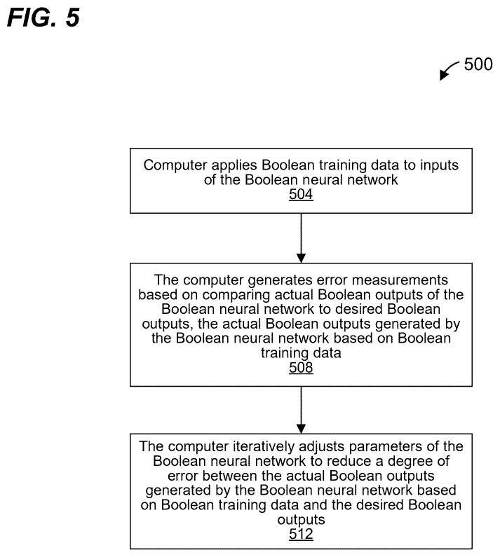

FIG. 5 is a simplified flow diagram of an example method 500 for training a Boolean neural network, according to an embodiment. The method 500 is implemented involves training the neural network 100 of FIG. 1, in an embodiment, and the method 500 is described with reference to FIG. 1 for case of explanation. In other embodiments, the method 500 involves training another suitable neural network different than the neural network 100 of FIG. 1. In some embodiments, the method 500 is implemented by a computing system such as the computing system 300 of FIG. 3, or another suitable computing system.

At block 504, a computer applies Boolean training data to inputs of the Boolean neural network.

At block 508, the computer generates error measurements based on comparing actual Boolean outputs of the Boolean neural network to desired Boolean outputs, the actual Boolean outputs generated by the Boolean neural network based on Boolean training data;

At block 512, the computer iteratively adjusts parameters of the Boolean neural network to reduce a degree of error between the actual Boolean outputs generated by the Boolean neural network based on Boolean training data and the desired Boolean outputs. In an embodiment, block 512 includes iteratively adjusting Boolean weighting parameters used by the second Boolean computational nodes to modify Boolean inputs to the second Boolean computational nodes.

In another embodiment, iteratively adjusting parameters of the Boolean neural network at block 512 comprises iteratively adjusting Boolean weighting parameters used by the first Boolean computational nodes to modify Boolean inputs to the first Boolean computational nodes.

In another embodiment, iteratively adjusting parameters of the Boolean neural network at block 512 comprises iteratively adjusting Boolean functions used by the second Boolean computational nodes to generate Boolean outputs.

In another embodiment, iteratively adjusting parameters of the Boolean neural network at block 512 comprises iteratively adjusting Boolean functions used by the first Boolean computational nodes to generate Boolean outputs.

In another embodiment, iteratively adjusting parameters of the Boolean neural network at block 512 comprises iteratively pruning Boolean inputs to the second Boolean computational nodes that are used by the second Boolean computation nodes to generate Boolean outputs.

According to various embodiments, neural networks such as described herein may be used to perform functions such as predictive modeling, adaptive control of machines, recognizing patterns in data, data compression, etc.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable tangible, non-transitory computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A neural network, comprising:
a first layer of first Boolean computational nodes, each first Boolean computational node configured to:
receive one or more first Boolean inputs, and
generate a first Boolean output based on the one or more first Boolean inputs; and
a second layer of second Boolean computational nodes, each second Boolean computational node configured to:
receive one or more second Boolean inputs, the one or more second Boolean inputs based on the first Boolean outputs generated by the first layer of first Boolean computational units,
generate one or more weighted second Boolean inputs by respectively applying one or more Boolean functions to the one or more second Boolean inputs, and
generate a second Boolean output based on the one or more weighted second Boolean inputs.

2. The neural network of claim 1, wherein each first Boolean computational node is further configured to:
generate one or more weighted first Boolean inputs by respectively applying one or more first Boolean functions to the one or more first Boolean inputs; and
generate the first Boolean output based on the one or more weighted first Boolean inputs.

3. The neural network of claim 1, wherein each of at least some of the first Boolean computational nodes is configured to:
implement a plurality of Boolean functions; and
generate a respective first Boolean output by applying a particular Boolean function to a set of Boolean values corresponding to a set of first Boolean inputs, the particular Boolean function selected from the plurality of plurality of Boolean functions.

4. The neural network of claim 1, wherein each of at least some of the second Boolean computational nodes is configured to:
implement a plurality of Boolean functions; and
generate a respective second Boolean output by applying a particular Boolean function to a set of weighted second Boolean inputs, the particular Boolean function selected from the plurality of plurality of Boolean functions.

5. The neural network of claim 1, wherein each of at least some of the second Boolean computational nodes is configured to:
prune one or more second Boolean inputs to the second Boolean computational node; and
generate the one or more weighted second Boolean inputs by respectively applying respective Boolean weighting functions to second Boolean inputs that are not pruned.

6. A method for processing Boolean data using a neural network, comprising:
receiving, at a plurality of first Boolean computational nodes in a first layer of the neural network, a plurality of first Boolean inputs;
generating, at the plurality of first Boolean computational nodes, a plurality of first Boolean outputs based on the plurality of first Boolean inputs;
receiving, at a plurality of second Boolean computational nodes in a second layer of the neural network, a plurality of second Boolean inputs, the plurality of second Boolean inputs based on the first Boolean outputs generated by the plurality of first Boolean computational nodes;
generating, at the plurality of second Boolean computational nodes, a plurality weighted second Boolean inputs by respectively applying, at the plurality of second Boolean computational nodes, respective Boolean weighting functions to at least some of second Boolean inputs in the plurality of second Boolean inputs, and
generating, at the plurality of second Boolean computational nodes, a plurality of second Boolean outputs based on the plurality weighted second Boolean inputs.

7. The method for processing Boolean data of claim 6, further comprising:
generating, at the plurality of first Boolean computational nodes, a plurality weighted first Boolean inputs by respectively applying, at the plurality of first Boolean computational nodes, respective Boolean weighting functions to the plurality of first Boolean inputs, and
wherein generating the plurality of first Boolean outputs comprises generating the plurality of first Boolean outputs based on the plurality of weighted first Boolean inputs.

8. The method for processing Boolean data of claim 6, wherein each of at least some of the first Boolean computational nodes is configured to implement a plurality of Boolean functions; and
wherein generating the plurality of first Boolean outputs based on the plurality of first Boolean inputs comprises generating, at each of the at least some of the first Boolean computational nodes, a respective first Boolean output by applying a particular Boolean function to a set of Boolean values corresponding to a set of first Boolean inputs, the particular Boolean function selected from the plurality of plurality of Boolean functions.

9. The method for processing Boolean data of claim 6, wherein each of at least some of the second Boolean computational nodes is configured to implement a plurality of Boolean functions; and
wherein generating the plurality of second Boolean outputs based on the plurality of weighted second Boolean inputs comprises generating, at each of the at least some of the second Boolean computational nodes, a respective second Boolean output by applying a particular Boolean function to a set of weighted second Boolean inputs, the particular Boolean function selected from the plurality of plurality of Boolean functions.

10. The method for processing Boolean data of claim 6, further comprising:
at each of at least some of the second Boolean computational nodes, pruning one or more second Boolean inputs to the second Boolean computational node;
wherein generating the plurality weighted second Boolean inputs comprises respectively applying, at the plurality of second Boolean computational nodes, respective Boolean weighting functions to second Boolean inputs in the plurality of second Boolean inputs that are not pruned.

11. A method for training a Boolean neural network that includes a first layer of first Boolean computational nodes and a second layer of second Boolean computational nodes, the method comprising:
applying, by a computer, Boolean training data to inputs of the Boolean neural network;
generating, by the computer, error measurements based on comparing actual Boolean outputs of the Boolean neural network to desired Boolean outputs, the actual Boolean outputs generated by the Boolean neural network based on Boolean training data; and
iteratively adjusting, by the computer, parameters of the Boolean neural network to reduce a degree of error between the actual Boolean outputs generated by the Boolean neural network based on Boolean training data and the desired Boolean outputs, including iteratively adjusting Boolean weighting parameters used by the second Boolean computational nodes to modify Boolean inputs to the second Boolean computational nodes.

12. The method for training the Boolean neural network of claim 11, wherein iteratively adjusting parameters of the Boolean neural network further comprises:
iteratively adjusting Boolean weighting parameters used by the first Boolean computational nodes to modify Boolean inputs to the first Boolean computational nodes.

13. The method for training the Boolean neural network of claim 11, wherein iteratively adjusting parameters of the Boolean neural network further comprises:
iteratively adjusting Boolean functions used by the second Boolean computational nodes to generate Boolean outputs.

14. The method for training the Boolean neural network of claim 11, wherein iteratively adjusting parameters of the Boolean neural network further comprises:
iteratively adjusting Boolean functions used by the first Boolean computational nodes to generate Boolean outputs.

15. The method for training the Boolean neural network of claim 11, wherein iteratively adjusting parameters of the Boolean neural network further comprises:
iteratively pruning Boolean inputs to the second Boolean computational nodes that are used by the second Boolean computation nodes to generate Boolean outputs.

16. A system for training a Boolean neural network that includes a first layer of first Boolean computational nodes and a second layer of second Boolean computational nodes, the system comprising:
one or more processors configured to execute machine readable instructions; and
one or more memories coupled to the one or more processors, the one or more memories storing machine readable instructions that, when executed by the one or more processors, cause the one or more processors to:
apply Boolean training data to inputs of the Boolean neural network,
generate error measurements based on comparing actual Boolean outputs of the Boolean neural network to desired Boolean outputs, the actual Boolean outputs generated by the Boolean neural network based on Boolean training data, and
iteratively adjust parameters of the Boolean neural network to reduce a degree of error between the actual Boolean outputs generated by the Boolean neural network based on Boolean training data and the desired Boolean outputs, including iteratively adjusting Boolean weighting parameters used by the second Boolean computational nodes to modify Boolean inputs to the second Boolean computational nodes.

17. The system of claim 16, wherein the one or more memories furth store machine readable instructions that, when executed by the one or more processors, cause the one or more processors to:
iteratively adjust Boolean weighting parameters used by the first Boolean computational nodes to modify Boolean inputs to the first Boolean computational nodes.

18. The system of claim 16, wherein the one or more memories furth store machine readable instructions that, when executed by the one or more processors, cause the one or more processors to:
iteratively adjust Boolean functions used by the second Boolean computational nodes to generate Boolean outputs.

19. The system of claim 16, wherein the one or more memories furth store machine readable instructions that, when executed by the one or more processors, cause the one or more processors to:
iteratively adjust Boolean functions used by the first Boolean computational nodes to generate Boolean outputs.

20. The system of claim 16, wherein the one or more memories furth store machine readable instructions that, when executed by the one or more processors, cause the one or more processors to:
iteratively prune Boolean inputs to the second Boolean computational nodes that are used by the second Boolean computation nodes to generate Boolean outputs.

21. The system of claim 16, further comprising:
the Boolean neural network communicatively coupled to the computer.
